(19) United States
(12) Patent Application Publication
(10) Pub. No.: US 2025/0226570 A1
(43) Pub. Date: Jul. 10, 2025

(54) Mechanically Mounted Traffic Rated Antenna

(71) Applicant: HADRONEX, INC., ESCONDIDO, CA (US)

(72) Inventors: Gregory M Quist, Escondido, CA (US); DAVID A DRAKE, Escondido, CA (US); WADE THOMAS MARTIN, New Braunfels, TX (US); RODGER ALBERT JOHNSON, New Braunfels, TX (US); RONALD WAYNE TOTEN, Laguna Niguel, CA (US)

(21) Appl. No.: 19/007,269

(22) Filed: Dec. 31, 2024

Related U.S. Application Data
(60) Provisional application No. 63/617,643, filed on Jan. 4, 2024.

(51) Int. Cl. H01Q 1/24; H01Q 1/42

(52) U.S. Cl. CPC H01Q 1/241; H01Q 1/42

(57) ABSTRACT

In order to support two-way radio communications from enclosed space areas, such as street manholes, an antenna is required to provide high signal quality for satellite, cellular, or radio frequency communications under high impact traffic conditions. On a wastewater manhole the antenna must provide efficient two-way communications as well as survive the frequent impacts of heavy, high-speed traffic. A common method of mounting is to use high strength adhesives to secure the antenna to the manhole cover. This becomes a permanent attachment, which can be costly and inflexible. Described is a mounting method and hardware that provides secure attachment and the ability to remove and remount a housing-protected antenna on an alternative manhole cover. This reduces waste and cost and labor for re-installation.

### CROSS-REFERENCE TO RELATED APPLICATION(S)

This application claims the benefit and priority of U.S. Provisional Patent Application No. 63/617,643, filed Jan. 4, 2024, the contents of which are hereby incorporated by reference in its entirety.

### FIELD

This invention is directed to the field of traffic rated antennas. Specifically, a manhole cover with mechanically rugged antenna module that supports rapid installation, removal, and re-installation on the attached substrate.

### BACKGROUND

Municipal enclosures typically utilize enclosure-sensing devices to monitor the health of the enclosure (a manhole, for example). Information from the sensing device(s) are often transmitted wireless from an antenna situated near, at or on the manhole cover. As these covers are routinely struck by the tires of passing vehicles, or by traffic management vehicles (e.g., snowplows), any exposed antennas (or their housing) will, over time, become damaged or dislodged from the cover. To prevent dislodgement, most antennas are permanently fastened to the cover with a layer of epoxy or similar. Therefore, the replacement or upgrading of the antenna without damaging the manhole cover is nearly impossible, or the effort to replace the antenna is overly time consuming.

In view of the above, there has been a long-standing need in the industry for a more convenient manhole cover antenna installation and/or replacement configuration as well as a more robust design of the antenna (housing) structure. Various designs and methods for addressing the above deficiencies are elucidated below.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, an antenna module removably mountable to a roadway manhole cover is provided, comprising: an impact resistant, electromagnetic-passing, traffic-rated, environmental housing, having a top surface, at least one downward tilted face on the top surface, a bottom surface, one or more attachment landings disposed proximal to a perimeter of the housing, and an attachment hole in the one or more attachment landings; at least one antenna in the housing, proximal to at least one of the top surface and the at least one downward tilted face, the at least one antenna being configured for at least one of a satellite and a cellular service; and a signal line connected to the at least one antenna and exiting the bottom surface, wherein an interior end of the attachment landing is taller than an exterior end of the attachment landing and the housing is smaller than a diameter of a roadway manhole cover.

In another aspect of the disclosed embodiments, the above antenna module is provided, wherein the at least one antenna is at least one of a chip antenna and dipole antenna; and/or further comprising a mounting plate configured to be attached to the bottom of the housing, the mounting plate being larger in width than the housing and having a first hole in alignment with the attachment hole, a second hole in alignment with the signal line, and at least one upward tab at a perimeter of the mounting plate, configured to prevent at least one of lateral movement of the housing when joined to the mounting plate and traffic impacts to a tab-located edge of the housing; and/or wherein the at least one downward tilted face is two faces on opposing sides of the housing; and/or wherein the one or more attachment landings are disposed at opposite ends of the housing; and/or wherein the housing is made of a non-brittle ceramic, a polycarbonate, plastic, or a composite material; and/or wherein the mounting plate is formed from a rigid metal; and/or wherein the mounting plate is formed from at least one of a plastic, ceramic, and graphite material and has an underlaying metallic layer to act as a ground plane for the least one antenna; and/or further comprising: a mounting plate configured to be attached to the bottom of the housing, the mounting plate being larger in width than the housing and having a first hole in alignment with the attachment hole, a second hole in alignment with the signal line and at least one upward tab at a perimeter of the mounting plate, configured to prevent at least one of lateral movement of the housing when joined to the mounting plate and traffic impacts to a tab-located edge of the housing; and an adhesive between the housing and the mounting plate, securing the housing and mounting plate to each other; and/or further comprising at least one of clips, bolts, screws, and swaging to attach the mounting plate to the bottom of the housing; and/or wherein the mounting plate is integral to the housing, being encapsulated during fabrication of the housing; and/or wherein the housing is rated up to 64,000 lbs of pressure; and/or further comprising: a mounting plate configured to be attached to the bottom of the housing, the mounting plate being larger in width than the housing and having a first hole in alignment with the attachment hole, a second hole in alignment with the signal line and at least one upward tab at a perimeter of the mounting plate, configured to prevent at least one of lateral movement of the housing when joined to the mounting plate and traffic impacts to a tab-located edge of the housing; and at least one of a screw and bolt, disposed in the attachment hole, configured to secure the housing and the mounting plate to a manhole cover; and/or further comprising a manhole cover, attached to a bottom of the mounting plate; and/or, further comprising a transceiver internal to the housing and connected to the at least one antenna.

In yet another aspect of the disclosed embodiments, a traffic rated antenna module removably mountable to roadway manhole cover is provided, comprising: an environmental impact resistant housing with recessed landings having attachment holes penetrating the housing; at least one embedded antenna on a top surface of the housing, configured for at least one of a satellite and cellular communication; a cable connected to the at least one embedded antenna, and exiting a bottom of the housing; and a mounting plate wider than the housing and having first holes in alignment with the attachment holes, and a second hole in alignment with the cable, the mounting plate having tabbed edges configured to prevent movement of the housing when joined to the mounting plate and shielding an end of the joined housing.

In yet another aspect of the disclosed embodiments, the above module is provided, wherein there the recessed landing are configured to prevent impact of tires upon securement means placed in the attachment holes; and/or wherein one or more sides of the housing is rounded; and/or wherein the mounting plate is configured as a ground plane for the at least one embedded antenna; and/or wherein the housing is manufactered from at least one of a non-brittle ceramic, a polycarbonate, plastic, or a composite material and the mounting plate is formed from at least one of a plastic, ceramic, and graphite material and has an underlaying metallic layer to act as a ground plane for the least one antenna.

### BRIEF DESCRIPTION OF THE DRAWINGS

FIG. 1 is a top perspective view of an exemplary traffic rated antenna module.

FIG. 2 is bottom view of an exemplary mounting plate.

FIG. 3 is a top view of an exemplary module, showing outlines of one or more antennas.

FIG. 4 is a generalized cross-sectional view of an exemplary traffic rated antenna module.

### DETAILED DESCRIPTION

In various embodiments, a mechanically rugged antenna module and system is described that supports rapid installation, removal, and re-installation on an alternative surface. This preserves the value of an expensive antenna, reduces labor costs, and lowers service visits and risking street personnel exposure.

As described below, one or more of the exemplary embodiments disclose a removable traffic rated antenna housing containing an interior antenna and/or a transmitter/receiver/pair, wherein the antenna is connected to a signal line that penetrates through a specially designed mounting plate, the mounting plate being coupled to an enclosure cover, such as a manhole cover.

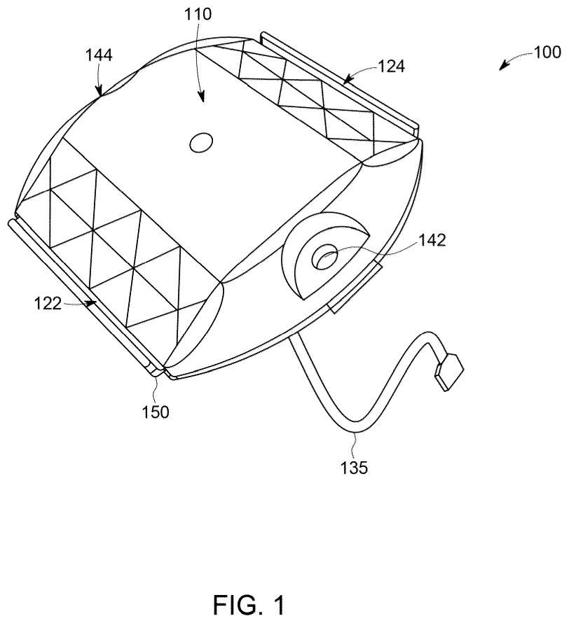

FIG. 1 is a top perspective view of an exemplary rugged antenna module 100, having a relatively smooth-sided rectangular-like body 110 with downwardly sloped opposing lateral faces 122, 124. The side profile of the body 110 has a taller mid-section vs. a lower/tapered end sections, thus can be considered dome-like, or near dome-like (from a side profile) in some embodiments. A signal carrying cable 135 is shown below the exemplary module 110. The exemplary module 110 for an experimental embodiment was approximately 3 inches wide, 3 inches in length, approximately 0.75 inches in height. Of couse, depending on implementation, the dimensions may vary. It is expressly understood that while a near rectangular form factor is utilized, other shapes or geometries may be implemented without departing from the spirit and scope of this disclosure. As non-limiting examples, a square, oval, disc shaped or faceted polygon shaped housing may be utilized.

A plurality of mounting holes 142, 144 are disposed at “forward” and “aft” of the body 110 through optional landings of the body 110, allowing the module 100 to be removably secured to a mounting plate 150 (a side edge thereof being seen at the bottom of the body 110). The term landing is used to describe a section(s) of the body 110 that is reserved for a securement means (described below) and describe some depression, a recess or alteration of the body 110 to allow the securement means to be attached. It is expressly understood that the mounting hole placement is one of design choice, noting, however, having the mounting holes 142, 144 near the ends of the body 110 allows for easier access and inspection, while also providing less “wobbling” of the body 110. Moreover, while only two perimeter-placed holes 142, 144 are shown here, it is possible to have additional holes at other locations, depending on design preference. For this particular embodiment, two holes 142, 144 on opposing ends were found to be sufficient for securing the body 110 to the mounting plate 150. The mounting plate 150 may also be adhered to the body 110 or may be joined to 110 mechanically before or during installation, as well as made integral to the body 110 during fabrication of the body 110.

The body 110 of the module 100 is an environmentally resistant, waterproof housing which can be formed from a resilient traffic rated material, some non-limiting examples being polycarbonate or ceramic materials or other traffic rated material. Traffic rated is a term of art, corresponding to transportation standard H40/HS-40, designated by the American Association of State Highway and Transportation Officials (AASHTO). HS-40 loading is specified for areas that will be subjected to extremely heavy truck traffic (such as truck stops, fire stations and mining facilities). The H40 design load is per AASHTO's M-306-10 load test requirements—proof load testing to 64,000 lbs. However, for purposes of this description, traffic rated can mean either the above or the lesser of—whereas the body 110 is sufficiently robust to withstand for long periods typical impacts from traffic and vehicles passing over the body 110. It goes without saying that the body 110, being used outdoors must withstand environmental conditions. In a best mode configuration, a significant part of the housing material is non-metallic or EM transparent so as to avoid interference with the antenna(s) (not shown). It is understood that the body 110 can be a compostion of various materials, according to design preference.

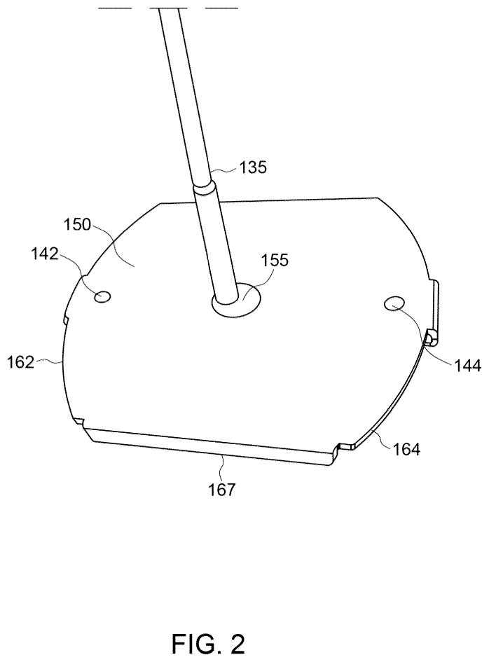

FIG. 2 is a bottom-side view of an exemplary mounting plate 150 showing the mounting holes 142, 144. In this particular embodiment, the mounting plate 150 is sized to be slightly larger than the body 110, wherein one or more edges of the mounting plate 150 serve to protect the body 110 from lower edge impacts. Specifically, for example, one or more edges or sides 167 of the mounting plate 150 can be tabbed upward (shown here as downward since the view is of the bottom of the mounting plate 150) to form a protective edge boundary to the body 110, as well as to prevent the body 110 from movement, once the mounting plate 150 and body 110 are secured to each other. The intent is that the body 110 fits snuggly onto the mounting plate 150, within edge flanges to provide extra protection from movement of the body 110. The tabbing can be performed through any one of many possible methods, non-limiting examples being swaging, mechanical forming, crimping, “clips,” etc. In some embodiments the tabs may fit through accomodations (not seen) in the body 110. The mounting plate 150 also serves to support the body 110 and distribute vehicle loads of the body's 110 to the mounting plate 150, thus reducing the possibility of cracking of the bottom of the body 110. Additionally, some manhole covers have an uneven top surface and the mounting plate 150 (if made to be flat) mitigates the bottom of the body 110 from contacting an uneven surface.

Apparent from this illustration is the general shape of the mounting plate 150 having a near rectangular form, with arched forward and aft ends (162, 164) to match to some degree the forward and aft curved boundaries of the body 110, described in FIG. 1. A signal line hole 155 is placed in the mounting plate 150, allowing passage of the signal line 135, and may be placed in the center of the mounting plate 150, if so configured. It is noted that while the term signal line is used, a coaxial cable or multi-line/cable or power line+signal line, etc. may be substituted, according to design preference.

Whilst the mounting plate 150 is shown here as having 2-axes of symmetry, it may be desirable to have one symmetric axis or a non-symmetric form, based on the geometry of the body 110 or, optionally, not-based on the geometry of the body 110. In any event, for this embodiment the mounting plate 150 is configured to closely “match” the bottom shape of the body 110. And as shown here, the main portion of the mounting plate 150 is planar in shape, formed from a stiff impact resistant material, such as aluminum, or steel. A conductive material for the mounting plate 150 is preferred as it improves the electrical ground plane for the body's 110 enclosed antenna(s). In some embodiments, the mounting plate 150 may be of a non-metallic composition or a hybrid of such. If so, then to faciliate the ground plane effect, a metallic substrate or layer may be placed within the non-metallic mounting plate. In various alternative embodiments, the mounting plate 150 may be significantly larger than the body 110, wherein the larger sections serve as independent mounting “flanges” to the manhole cover (not shown) that are separate or distal from the body 110. This can be facilitated by extending the forward and aft ends (162, 164) or having some lateral extension on the lateral sides.

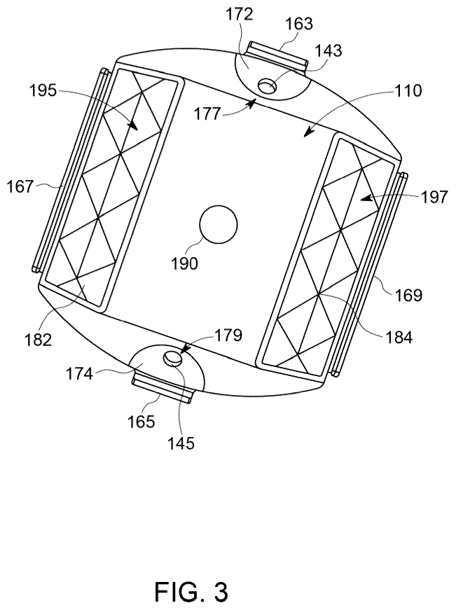

FIG. 3 is a top view of an exemplary module 100, showing outlines of one or more antennas 182, 184 and 190. These antennas can be of various sorts and types, operate at different frequencies, etc. In this particular example, antennas 182 and 184 are “dipole-like” antennas operating in L or S bands, while antenna 190 is a “chip” antenna operating in L or S bands. These bands support current wireless networks such as low earth orbit satellites (e.g. Iridium, Starlink, etc.) and terrestrial cell phones. By having different antennas in the module 100, different bands and services can be utilized. Of course, depending on the communication capabilities of the servicing network, the frequencies will be different than described and therefore alternate frequencies and/or antenna types (and more or less antennas) are understood to be within the purview of this disclosure. Such systems may include cellular, satellite, wifi, or any applicable wireless system.

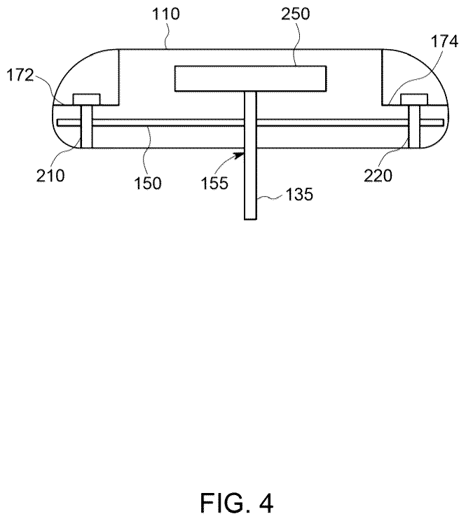

In an exemplary embodiment, the module 100 also contains one or more transmitters (seen in FIG. 4) coupled to the antennas 182, 184 and 190 and the transmitter(s) may also act as a transceiver(s). As described in FIG. 2, a cable or signal line, etc. (not shown) is coupled to the module 100 and is understood to penetrate into the enclosure cover (e.g., manhole cover) to any “connecting” devices within the enclosure. It is expressly understood that in some embodiments, the module 100 can be configured to contain power systems, control systems, processing systems as deemed necessary, to facilitate the functions of the antennas disposed therein.

In some systems it is understood that the primary “inside enclosure” sensing capabilities are not in the module 100 but disposed within the enclosure (e.g., manhole) and the module 100 may be designed to only provide the wireless endpoint. For example, it is fully contemplated that various projects utilizing the exemplary modules 100 may operate with different communication systems at different stages of the projects (one may utilize cellular networks at first, then later transition to a satellite system). Thus, only the wireless module 100 may need to be “upgraded” while the manhole sensing system can remain untouched, thus providing a cost savings to the project. Of course, as noted above, the antennas 182, 184 and 190 in the module 100 may already be configured to provide all the desired modes of wireless communication.

The body 110 of the module 100 can have faceted ends or faces 195, 197 wherein one or more of the antennas 182, 184 and 190 are situated, thus having a form factor that is complementary to the antenna(s) and also provide (via the angles of faceting, or “tilting”) easier vehicle travel onto and over the body 110. A centrally located antenna 190 can also be provided. As noted above, the body 110 can be dome-shaped, or some variant thereof, having a lower perimeter “ends” to facilitate better lateral impact resistance. The lower profile of the body 110 around the perimeter serves to reduce lateral forces to the module 100 when a tire strikes it. A key factor in the road longevity of the module 100 are recessed notches or attachment landings 172, 174 at each end of the housing 110. The landings 172, 174 have landings holes 143, 145 that are in alignment with mounting plate holes 142, 144. The size of the landings can be wide enough that a “semi-circular” wall 177, 179 bounds the interior extent of the landings 172, 174, providing a higher elevation than the exterior extent of the landings 172, 174. At the exterior perimeter of the landings 172, 174, alignment and/or protection tabs 163, 165 from the mounting plate 150 are visible. Likewise, at the exterior perimeter of the sides 195, 197 are similar alignment and/or protection tabs 167, 169 from the mounting plate 150. Of course, the specific placement and number of landings 172, 174, their shapes and the protection tabs 163, 165, 167, 169, can be altered according to design preference.

The landing/notches 172, 174 are deep enough withing the body 110 to prevent secured screw or bolt heads (not shown) from protruding above a side or top face of the body 110 and therefore keep them away from traffic impacts. As traffic impacts can deform the screw or bolt heads, rendering them unsuitable when attempting to remove the body 110. The screw or bolt heads can be either conventional Phillips heads, hex heads, security patterned heads, or round top heads that prevent removal from the top, and so forth.

In a deployment scenario, the mounting plate 150 can be “mated” to the enclosure lid (e.g., manhole cover) via notches, flanges, depressions and the like. And the body 110 can be secured to the mounting plate 150 with high strength adhesives. Or the mounting plate 150 could also attach to the body 110 with spring clips, screws and holes or be fabricated with injection molding. Or the mounting plate 150 may not be physically attached to the body 110, but secured via the mounting means to the manhole cover itself. In one possible example, the mounting plate 150 could provide a mating structure where the body 110 is “swiveled” into a locked position and then mechanically secured in accordance to one or methods described above.

In a best mode embodiment, to prevent tampering, the screw or bolt head configuration is such that the module 100 cannot be removed without lifting the manhole cover (not shown) and removing the coupling “nuts” or securing elements from below (inside the manhole). The screws or bolts pass through the mounting holes 142, 144 and landings holes 143, 145 to continue through the manhole cover and are secured by typical mechanical means such as lock washers and nuts below the manhole cover. These mounting screws provide a secure attachment, but also allow for “unsecurement” when desired for easy removal and placement of the module 100. This allows for more rapid installation and preserves the value of the module 100 for future use.

FIG. 4 is a generalized cross-sectional view of an exemplary embodiment, showing one or more of the elements noted above. For example, landing/notches 172, 174 within body 110, having screws 210, 220 thorough holes 143, 145 (142, 144) within the body 110 and mounting plate 150 (holes being occupied by the screws 210, 220). Additionally a signal line hole 155 is disposed in the mounting plate 150 passing a signal line 135 which is coupled to an a center antenna and/or transceiver 250 connected to antennas (not shown). It is noted here, the “sides” of the housing 110 are shown as rounded. It is understood that roadways have a preferential traffic direction, therefore, depending on the “direction” of traffic flow, the shape of the housing 110 may be also be made to be preferential to that direction. That is, for example, sides of the housing 110 may be more acutely angled when aligned with traffic direction, while other non-traffic sides may be less angled. Of course, this is according to design preference and may vary accordingly.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An antenna module removably mountable to roadway manhole cover, comprising:
an impact resistant, electromagnetic-passing, traffic-rated, environmental housing, having a top surface, at least one downward tilted face on the top surface, a bottom surface, one or more attachment landings disposed proximal to a perimeter of the housing, and an attachment hole in the one or more attachment landings;
at least one antenna in the housing, proximal to at least one of the top surface and the at least one downward tilted face, the at least one antenna being configured for at least one of a satellite and a cellular service; and
a signal line connected to the at least one antenna and exiting the bottom surface,
wherein an interior end of the attachment landing is taller than an exterior end of the attachment landing and the housing is smaller than a diameter of a roadway manhole cover.

2. The antenna module of claim 1, wherein the at least one antenna is at least one of a chip antenna and dipole antenna.

3. The antenna module of claim 1, further comprising a mounting plate configured to be attached to the bottom of the housing, the mounting plate being larger in width than the housing and having a first hole in alignment with the attachment hole, a second hole in alignment with the signal line, and at least one upward tab at a perimeter of the mounting plate, configured to prevent at least one of lateral movement of the housing when joined to the mounting plate and traffic impacts to a tab-located edge of the housing.

4. The antenna module of claim 1, wherein the at least one downward tilted face is two faces on opposing sides of the housing.

5. The antenna module of claim 1, wherein the one or more attachment landings are disposed at opposite ends of the housing.

6. The antenna module of claim 1, wherein the housing is made of a non-brittle ceramic, a polycarbonate, plastic, or a composite material.

7. The antenna module of claim 3, wherein the mounting plate is formed from a rigid metal.

8. The antenna module of claim 3, wherein the mounting plate is formed from at least one of a plastic, ceramic, and graphite material and has an underlaying metallic layer to act as a ground plane for the least one antenna.

9. The antenna module of claim 1, further comprising:
a mounting plate configured to be attached to the bottom of the housing, the mounting plate being larger in width than the housing and having a first hole in alignment with the attachment hole, a second hole in alignment with the signal line and at least one upward tab at a perimeter of the mounting plate, configured to prevent at least one of lateral movement of the housing when joined to the mounting plate and traffic impacts to a tab-located edge of the housing; and
an adhesive between the housing and the mounting plate, securing the housing and mounting plate to each other.

10. The antenna module of claim 3, further comprising at least one of clips, bolts, screws, and swaging to attach the mounting plate to the bottom of the housing,

11. The antenna module of claim 3, wherein the mounting plate is integral to the housing, being encapsulated during fabrication of the housing.

12. The antenna module of claim 1, wherein the housing is rated up to 64,000 lbs of pressure.

13. The antenna module of claim 1, further comprising:
a mounting plate configured to be attached to the bottom of the housing, the mounting plate being larger in width than the housing and having a first hole in alignment with the attachment hole, a second hole in alignment with the signal line and at least one upward tab at a perimeter of the mounting plate, configured to prevent at least one of lateral movement of the housing when joined to the mounting plate and traffic impacts to a tab-located edge of the housing; and
at least one of a screw and bolt, disposed in the attachment hole, configured to secure the housing and the mounting plate to a manhole cover.

14. The antenna module of claim 3, further comprising a manhole cover, attached to a bottom of the mounting plate.

15. The antenna module of claim 1, further comprising a transceiver internal to the housing and connected to the at least one antenna.

16. A traffic rated antenna module removably mountable to roadway manhole cover, comprising:
an environmental impact resistant housing with recessed landings having attachment holes penetrating the housing;
at least one embedded antenna on a top surface of the housing, configured for at least one of a satellite and cellular communication;
a cable connected to the at least one embedded antenna, and exiting a bottom of the housing; and
a mounting plate wider than the housing and having first holes in alignment with the attachment holes, and a second hole in alignment with the cable, the mounting plate having tabbed edges configured to prevent movement of the housing when joined to the mounting plate and shielding an end of the joined housing.

17. The antenna module of claim 16, wherein there the recessed landing are configured to prevent impact of tires upon securement means placed in the attachment holes.

18. The antenna module of claim 16, wherein one or more sides of the housing is rounded.

19. The antenna module of claim 16, wherein the mounting plate is configured as a ground plane for the at least one embedded antenna.

20. The antenna module of claim 16, wherein the housing is manufactered from at least one of a non-brittle ceramic, a polycarbonate, plastic, or a composite material and the mounting plate is formed from at least one of a plastic, ceramic, and graphite material and has an underlaying metallic layer to act as a ground plane for the least one antenna.
